(19) United States
(12) Patent Application Publication
(10) Pub. No.: US 2005/0215267 A1
(43) Pub. Date: Sep. 29, 2005

(54) Information transmitting and encryption method and apparatus

(76) Inventor: Brian R. Cartmell, Mercer Island, WA (US)

Correspondence Address: John P. Luther, Esq.;Newman & Newman, LLP, Suite 610, 505 Fifth Avenue South, Seattle, WA, 98104, US

(21) Appl. No.: 10/811,029

(22) Filed: Mar. 26, 2004

(51) Int. Cl. H04Q 7/20

(52) U.S. Cl. 455/456.1; 455/412.1

(57) ABSTRACT

The present invention provides a method and system for the transmission of text, sound and images between a sender and a receiver location for receiving coordinate or location coded transmitted information, and providing text, sound and images by processing said transmitted information via paired coordinate information in a location database.

### FIELD OF THE INVENTION

The present invention relates to an information, image, sound and data transmitting method and apparatus which outputs location and/or coordinated related information to a source for location, retrieval and reconstruction, and also to an information, image, sound and data encoding method which transforms such information and the like into coordinate/location encryption or code for latter transmittance and reconstruction at a source site for retrieval.

### BACKGROUND OF THE INVENTION

This invention generally relates to an improved method and apparatus for transmitting information relating to the coordinates and/or location of images, sound, text and other data and tangible mediums as desired, such as human readable text and human decipherable visual displays in the form of messages, reports, books, spread sheets, plans, drawings, pictures, films, music and other sounds from one location to another, perhaps remote and inaccessible, location in a compact easily accessible format and within a rapid time frame.

As information and data transfer has become evermore complex in recent years, particularly as the subject matter itself has increased in complexity, the need for speed and simplicity of such transmissions has become increasingly important, with security considerations oftentimes at the forefront of priorities. In recent years a myriad of various types of information providing systems have been developed in which an information providing apparatus (e.g. server) dispatches various types of information to an information receiving apparatus of one or more respective users through or by dedicated data transmission paths. Such transmission paths have been enabled, for example, through Internet means as dispersed to various users at business sites, or broadcast through radio or television signals, in the form of character data transmitted as vertical blanking intervals of a broadcast signal. Such methods generally are implemented by a user transmitting a request to an information apparatus provider with respect to specific informational content, such as written text or various types of catalog information. The conventional information providing apparatus responds to such a request, for example, by converting the requested information into HTML format data and then dispatching all of the resulting data to a terminal through an Internet communication path, or by broadcasted radio waves, or transmitted to a user's television receiver through known techniques such as VBI.

An example of a conventional communicating network and transmission protocol is shown in U.S. patent application Publication No. 2003/00744 60 where there is described a protocol which communicates data relating to network variables in a LON control network. The method uses a plurality of device controllers for controlling a plurality of network devices and a system controller for controlling the device controllers. The protocol utilizes a method identification field for communicating one of several predefined messages and a protocol identification field for identifying several predefined messages being communicated by a proprietary and secure communication protocol. This method also discloses a control system for controlling several network devices in a LON control network system which uses network variables and several device controllers in communication with the network devices. The control system is also said to include in addition to system controllers for controlling device controllers, corresponding network variable servers in communication with device controllers, controllers for sending and receiving a plurality of predefined messages relating to one or more select network variables to and from device controllers and a system controller via a secure communication protocol. For messages which contain data strings, a length field is provided which indicates the byte and size of a buffer field which holds the data string. Network variable (NV) protocol messages are described as being of a serialized data structure with bytes stored in a predefined order, preferably “big-endian” which favors placing the most significant or largest digits first in a numerical encoding scheme, as opposed to “little-endian”, or putting the most significant digits last. (See Jonathan Swift's Gulliver's Travels as to the origin and significance of big and little-endian terminology).

In another method, U.S. patent application Publication No. 2003/0028632 discloses logging multicast data messages in a communications network in an effort to overcome inherent problems with unicast methodology in multiple subscribing applications, such as Transmission Control Protocol (TCP) and User Datagram Protocol (UDP) in which a publishing application is required to transmit a different message to every subscriber which can easily overwhelm the system leading to system failure. In this method, a network system is configured to facilitate packet switched transmission of text, audio, video, voice over Internet Protocol (VOIP) multimedia, and other data formats. The method is also designed to work in conjunction with any of the several known protocols, such as, for example, Transmission Control Protocol/Internet Protocol (TCP/IP), Hypertext Transfer Protocol (HTTP), Simple Mail Transfer Protocol (SMTP), Asynchronous Transfer Mode (ATM), Real-Time Transport Protocol (RTP), Real-Time Streaming Protocol (RTSP), Session Announcement Protocol (SAP), Session Description Protocol (SIP) and various other conventional products enabling packet-switched data transmission. Network access devices coupled with communications networks enable data communication between or among such devices, which can also be coupled with peripheral devices, inclusive of a telephone or wireless communications device. Network access devices can be, for example, personal desktop or laptop computers, workstations, personal digital assistants (PDAs), personal communications systems (PCSs) or any other network enabled device. The individual networks can be coupled to other network devices, such as storage media, application servers, telephone network servers and wireless telephone base-stations. This multicast logging system is also said to comprise log clients publishing messages to multicast addresses, log servers subscribing to one or more multicast addresses and “persist selected data” transmitted to the multicast addresses, all of which can reside on a network server or in one or more system components, such as software modules, provided that two-way data communications between and among system components is enabled. This system is said to be an improvement over other communications methods by utilization of a specific range of values in a “time-to-live” field (TTL) in a packet header. As mentioned, the TTL field can define and/or control a data packets geographic scope, or the distance a packet may travel from its originating source to its desired destination.

In yet another disclosed system, U.S. Pat. No. 6,564,265 provides a method for processing a data signal which can encode a data bit stream carrying a sequence of data packets. A protocol specification, including a specification of a number of elements, is processed with each specification including a length and a name, which may also include internal structure and actions. A communication processing device accepts and processes a data signal which is segmented into a packet sequence by a packet detector, with each packet in a sequence processed by a decoder in sequence. The packets are then processed according to a protocol specification which defines packet types, including the structure and meaning (syntax and semantics) of the packets and actions to take upon reading of elements represented in the packets. Thus, for each packet information, decoded actions are performed as specified in the protocol specification, for example, producing 0,1 or more parameterized messages, or other signals, that are passed to a message processor which makes use of the information in the messages to produce the desired result, i.e. a presentation of information in input packets to a user. Examples of information-containing signals which can be accepted include digitized multimedia information such as multiplexed video, audio or other data. Additionally, a packet detector is configured to locate individual packets (“Fromes”) which can be based on synchronization data in a data signal, or signal voltage levels. A finite length bit of sequence is forwarded from a packet detection device to a packet decoder for every packet located, and each packet is processed in turn with the packet decoder outputting appropriate messages to a message processor, and with each message defined by a specific parameter scheme from the input bit stream for the packet being processed. Messages from a processor can be displayed on a video, monitor or audio played on speakers. An information packet generator is also included which will form packets with information formats defined by a protocol specification. A packet constructor is also provided to accept a packet sequence from a packet generator to encode an information stream and form data signals which are input and signals which are output, such as executable software.

In a different scheme, a method of transmitting location related information is discussed in U.S. Pat. No. 6,388,019. In this system information is transmitted from a navigational device to a receiver for digitally coded traffic messages on the basis of coordinates, such as the appropriate location in a table in a TMC system in which digitally coded traffic messages are generated on a transmitter side and decoded in receivers. For a discussion of the TMC system, reference is made to European Patent No. 0 263 332 and German Patents Nos. 3810 177 and 3810 179. As described on the basis of such coordinate information, location of information in a table/TMC system is found by approximation and comparison of descriptors. A receiver of the digital traffic messages, referred to as a TMC receiver in this method, is used to create a message and to communicate it to a user, for example, using some form of human language.

In yet another scheme, U.S. Pat. No. 6,157,642 discloses a data communication system for a constellation of low-Earth orbit (LEO) satellites, which employs Earth-fixed cellular beam management technology. In this method, as in others discussed above, data is formed into data packets by a ground transmitting terminal, with each packet including a header and a payload. The header contains address and other control information and the payload contains data to be communicated. Upon receipt by an uplink satellite data packet codes are processed and codes are routed to a determined downlink satellite which also processes data codes and forwards the information to a receiving ground terminal, which recovers the header and payload.

A further satellite communication system is disclosed in U.S. Pat. No. 6,157,621 which is said to be capable of offering continuous voice, data and video service to customers across the globe, on the land, on the sea or in the air. As in the above described method, a low-Earth orbit satellite system is employed which includes a multiplicity of spacecraft, 40, traveling in each of 21 orbital planes at an altitude of 435 miles. As mentioned, the large number of satellites employed is to provide continuous coverage of the Earth's surface at a high minimum mask angle of forty degrees. As further explained, each of the individual 840 spacecraft (40 spacecraft traveling in 21 orbital planes) is said to function as an independent sovereign entity knowing the position of its neighbors and capable of independently handling traffic without ground control. The satellites can also transport calls to millions of customers using portable mobile and fixed residential and business terminals and other gateways to public phone works. Additionally, the system is described as designed to support more than 2,000,000 simultaneous connections, representing over 20,000,000 users at typical business usage levels, and over 350 million minutes of use per year. Additional satellite communication systems are disclosed, for example, in U.S. Pat. Nos. 6,127,967; 6,011,951; 5,995,841; 5,936,570; 5,822,680; 5,736,959; 5,678,175; 5,548,294; 5,408,237; 5,379,224; 5,225,842; 4,862,178; 4,849,961; and 4,706,286.

In still other information transfer methods, such as disclosed in U.S. Pat. No. 6,22,855 , a device is provided that will enable data processing and communication from one protocol to another, different protocol, to allow communication between a series of networked communications equipment. The advantage of this system is said to be the allowance of a number of different types of peripheral devices to be used in switching systems which employ Dual Serial Channel (DSCH) cabling. See also, for example, U.S. Pat. No. 6,125,122 which describes an established communication protocol between different network nodes.

As can be seen, many methods for transmitting and receiving information in the form of text, images and sound virtually anywhere are known and available. However, many, if not all, of such conventional information transmitting methods become undesirable at times due to time requirements and excessive cost in transmitting data or text information of any length or volume, such as reports, plans, blueprints, books, or musical presentations, images and the like, especially to remote or inaccessible areas, such as to undersea, mountainous and airborne locations.

It is therefore desirable as an object of the present invention to provide a method and apparatus for implementing such method in which communication costs and the complexity of processing involved with providing and obtaining information, such as human readable text, or images or sound, is dramatically reduced along with associated costs, and which further provides virtually unlimited accessibility anywhere on the planet, whether on land, undersea or in space.

### SUMMARY OF THE INVENTION

In accordance with that set forth above, the present invention provides a method and apparatus for transmitting human readable text and/or human or animal decipherable sound or image data or subject matter (collectively, “information”) comprising the transmission of coordinates or location related information from one source local to another, which includes a transmission means further comprising a first location database in which location/coordinate information from a descriptor means are assigned to location specifications in an information reservoir or retrieval means, depending upon an information transcription protocol, and receiver/locator means for receiving coordinate or location related information, which may be, for, example, digitally coded message information. The receiver/locator means contains a second location database which processes transmitted and received location/coordinate information from the descriptor means into human readable text and/or human or animal decipherable sound or images via available text, images or sound text, for example, from satellite source reservoirs or content reservoirs situated in any location. The inventive method and system further comprises location/coordinate paired information in location specifications stored in the second location database to which information comprising text, images or sound in a content reservoir relates, and with the assistance of the paired location/coordinate information in the second location database enables the location and reconstruction and retrieval by the recipient of human readable text or human and/or animal decipherable sound or images. The invention and various features and embodiments thereof is best understood from the following Detailed Description of Preferred Embodiments with reference to the Drawings.

### BRIEF DESCRIPTION OF THE DRAWINGS

FIG. 1 illustrates by schematic view a connection between a sender of text, sound or visual display and a receiver location for receiving coordinate or location coded transmitted information, and providing human readable text, and/or human and animal decipherable sound and images by processing said transmitted information to retrieve the desired text, sound or image display from a reservoir or location of text, sound and images.

FIG. 2 illustrates an example of human readable text which can be transmitted by coordinate or otherwise location related information in accordance with the present inventive method and apparatus.

FIGS. 3-4 schematically illustrate an uplink satellite connection between a sender of text, sound or visual image display in the form of location or coordinate encrypted information and a receiver location for receiving the encrypted transmitted information, and for providing human readable text and/or human and animal decipherable visual display images and sound by processing said transmitted encrypted information and then retrieving the desired textual information, visual image display or sound from a satellite reservoir data storage (which may be an Internet-satellite link) of text, visual display and sound data or subject matter.

FIG. 5 illustrates a variety of encrypted location information retrieval and reconstruction locals which are possible embodiments of the present invention.

### DETAILED DESCRIPTION OF PREFERRED EMBODIMENTS

All patent references, published patent applications and literature references referred to or cited herein are expressly incorporated by reference to the same extent as if each were specifically and individually indicated to be incorporated by reference. Any inconsistency between these publications and the present disclosure is intended to and shall be resolved in favor of the present disclosure.

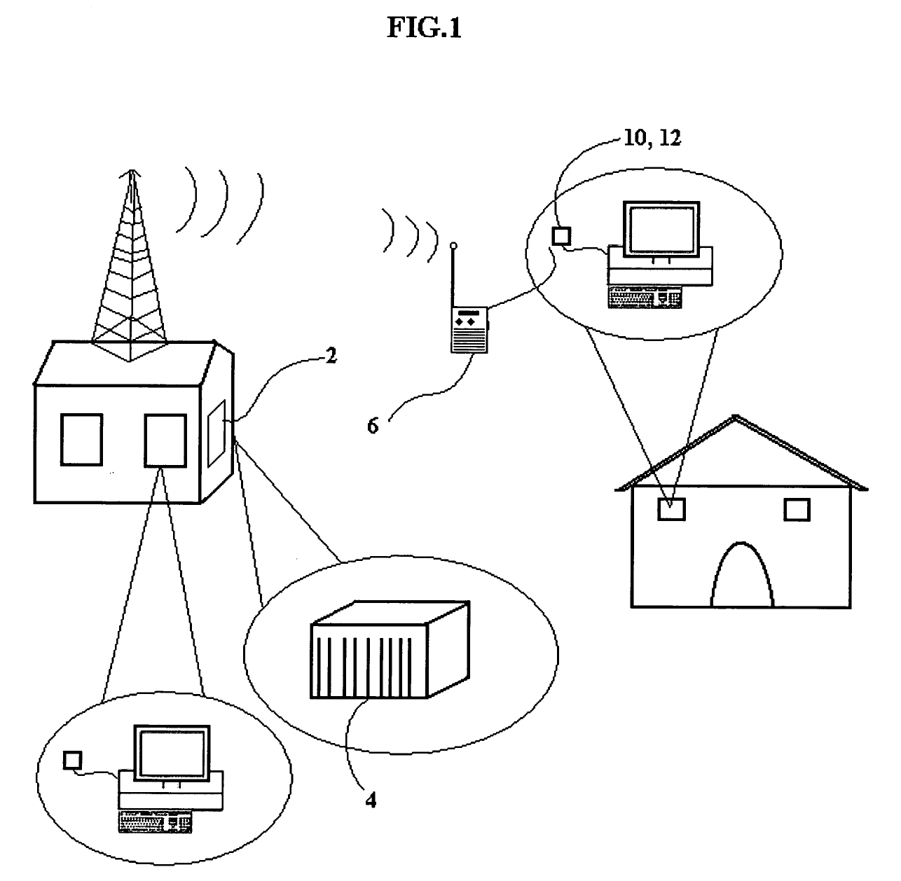

In accordance with the present invention there is provided an efficient, convenient and secure compact method and system for transferring information in the form of human readable text, and human and animal decipherable sound, such as music or commands, and visual image displays (all collectively “information”) from one location to another throughout the world, notwithstanding whether the receiver of such information is situated at a surface or undersea location, or located in space. Referring now to FIG. 1, schematically depicted are the basic components and means necessary to understand the present inventive method and system in one of several preferred embodiments. As shown, there is included a first location database (2) which can assign location/coordinate information (4), for example, in a descriptor means (6), to location specifications in a content reservoir (8), such as the Internet, depending upon a particular information transcription protocol, such as, for example, relating to the location or coordinates of subject matter which constitutes textual material to be read by humans, or that which constitutes images or sounds, e.g. musical material and the like, as the case my be. The location/coordinate information is then transmitted, for example, by electromagnetic waves, e.g. radio, from a transmitting means (6a) via a sender (6b).

A receiver means (10) inclusive of, or working in conjunction with, a locater means (12) is to receive the coordinate or location related information (4), such as, for example, digitally coded message information. The receiver/locater means (10), (12) is equipped with, or equipped to work with or otherwise is in communication with, a second location database (14) to which the transmitted coordinate information and/or location information relates, to provide human readable text, sound and visual display information. More particularly, the second location database (14) comprises location/coordinates paired information (16) which when paired, or otherwise processed, with incoming location/coordinate information to which the incoming information relates produces transmitted information in the form of human readable text, sound or visual image display, as desired. The location/coordinate paired information (16) is in communication with a library, source, or content database (18), which is preprogrammed to comprise symbols, letters, numerical information, dictionary and encyclopedic text in any number of different languages or script, or complete text book or book resources, treatises and the like comprising, for example, any scientific, literary, or historical discipline. Library database (18) may also comprise a library of music or individual notes, tones and octaves and percussion information in various decibels for musical composition or sound wave information, and may further comprise imagery production means, such as, for example, an array of pixels corresponding to any size, shape and color for the production of any type of visual image display, such a graphic display or the presentation of a movie or film. In short, library database (18) may be comprised of everything accessible on the Internet, or it may be Internet accessible through a protocol server (not shown).

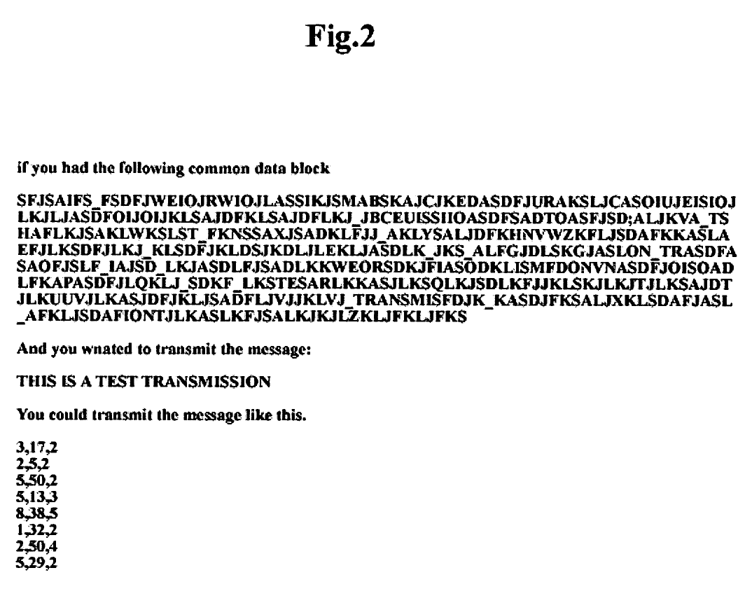

As shown by example in FIG. 2 a string of a human readable text message which can be location/coordinate encrypted by the present invention and then transmitted, received, retrieved and reconstituted is illustrated. As will be appreciated, a rather large and bulky message can be reduced to a compact bundle of information for efficient, speedy and low cost transmission of whatever information medium is encrypted, be it readable text, sounds, such as music or voice recognition biometrics, or imagery, such as movies or artworks. Digitization of such encrypted information provides even more advantages.

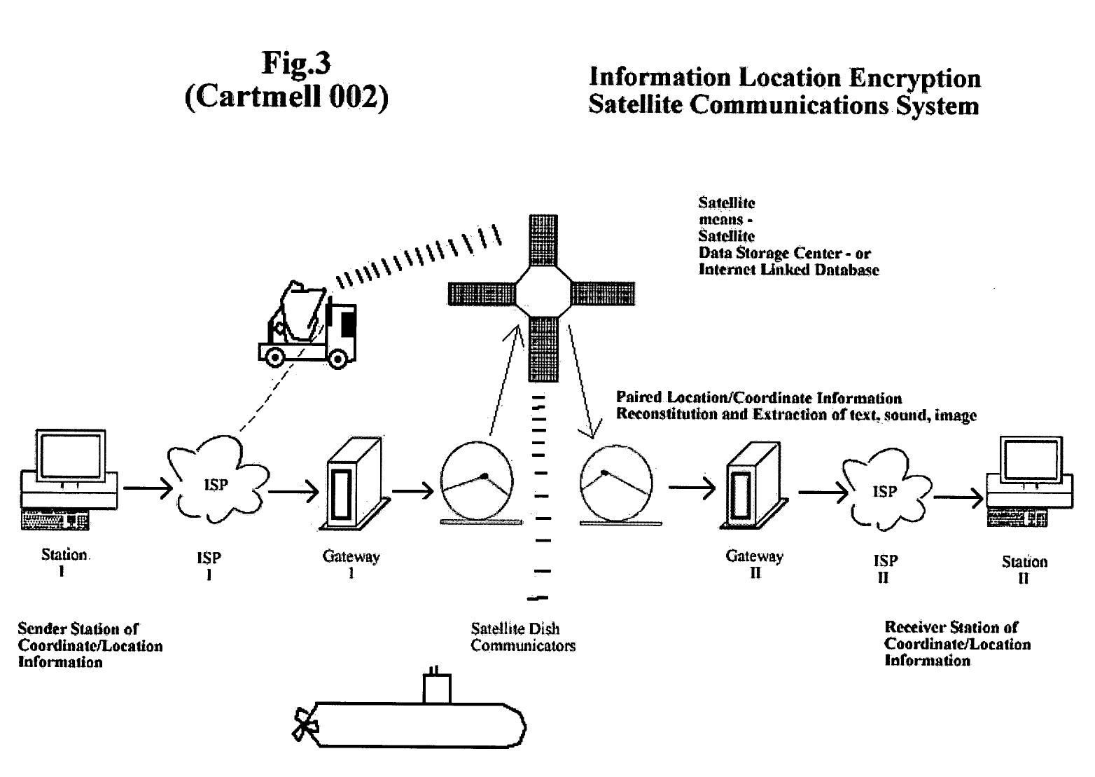

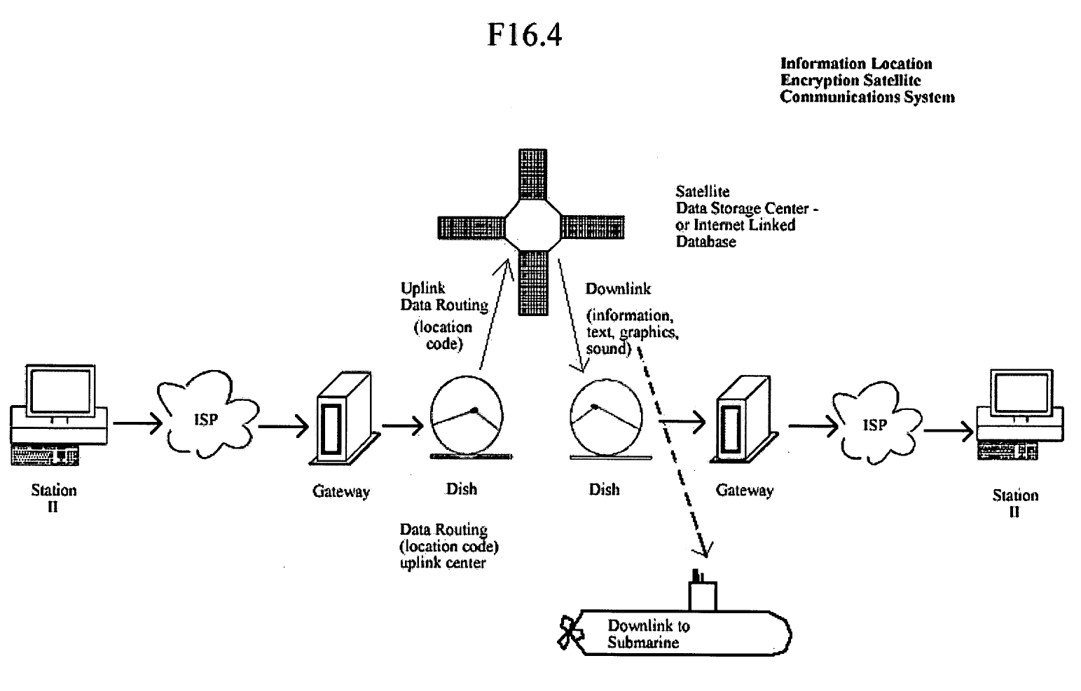

In some preferred embodiments in accordance with this invention, the transmission, receipt of, retrieval and reconstruction of location/coordinate encrypted information can be accomplished from a satellite-based data base or reservoir storage center of text, sounds and image displays, or a satellite-based link to Internet access for such information. Referring now to the embodiments depicted in the schematic diagrams of FIGS. 3 and 4, a user/sender transmission station (20) of location/coordinate encrypted information, such as an encrypted message of text (see FIG. 2), sound or imagery, connects through an ISP (22) to a first gateway (24) which communicates the encrypted message or material via a first satellite communications antenna or dish (26) to a satellite means (28). The transmission station (20) comprises a transmission means (not shown) in which is included a first location database wherein location/coordinate assigned information are assigned to location specifications, depending upon an information transcription protocol, such as letters, syllables, text, notes, tones, bars of music or image pixels and the like. As is known, a transmission sent from a station on Earth to a satellite is called an “uplink” which is in the form of an electromagnetic wave signal (radio wave) at a frequency in the Gigahertz (GHz) range. The satellite, in its orbit about the Earth, receives the signal and then transmits it back to Earth stations. This transmission is called a “downlink”. Receiving stations within the coverage area of the satellite, called the satellite's “footprint”, are enabled to receive the satellite's downlink signals. As is further known, satellite transmission signals, up and downlinks, are typically transmitted on certain frequency bands, as assigned by the International Telecommunications Union based in Geneva, Switzerland, with the bands most frequently used being a C-band and Ku-band, having uplink and downlink frequencies of 6 GHz and 4 GHz, and 14 GHZ and 11 GHZ, respectively. While the C-band often requires a satellite antenna (dish) of from 2-3 meters in diameter, the higher frequency (lower wavelength) Ku-band requires a much smaller satellite antenna of sometimes only 18 inches in diameter, which are typically used as home entertainment satellite dishes. Owing to their small size these antennas/dishes can be mounted and/or transported practically anywhere as desired and provide for some preferred embodiments of the present invention. Some satellite antenna/receivers are of the size of a dollar bill, and may be easily carried with a laptop computer/Internet access device, and are especially preferred for use with the present invention

Information or messages that are desired to be sent by satellite are oftentimes not in a format suitable for direct transmission, but must be changed, or “modulated”, into either analogue or digital form in an uplink, and “demodulated” in a downlink receiving station. Thus as shown in FIGS. 3-4, a downlink signal comprising suitably modulated location/coordinate encrypted information or material is received by a second communications antenna or dish (30) from satellite means (28) and is thereafter demodulated and routed through a second gateway (32) to a second ISP (34), and finally to a receiving station (36). In this embodiment, the receiving station (36) comprises, or otherwise operates in conjunction with, a descriptor means (38), which may be a second location database (40) which processes transmitted and received location/coordinate information into human readable text and/or human and animal decipherable sound and image display from available library/source/reservoir databases situated in any location, such as located in satellite means (28) in this exemplified embodiment. The second location database (40) comprises, or is associated therewith, a location/coordinate paired descriptor means (38) of location specifications to which the transmitted encrypted message relates, and from which text, sound and images may be retrieved and reconstructed from a library database, such as located in satellite means (28) or as located through an Internet connection. As shown, the demodulated encrypted message received by station (36) is paired in the descriptor means (38) to quickly and precisely locate and produce, or otherwise make available, subject matter found at assigned locations in the library database to provide text, sounds and images as desired by the receiver.

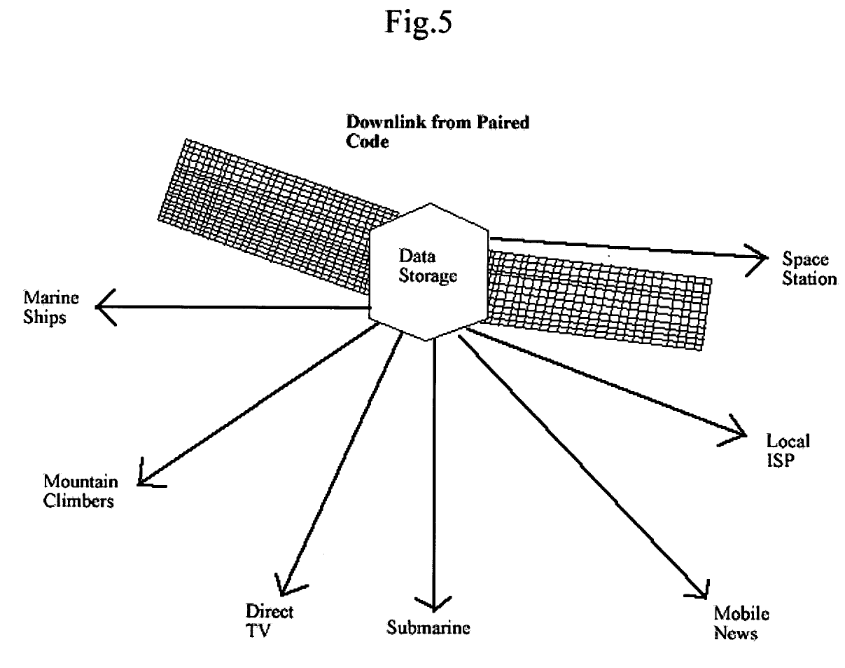

While satellite systems are but one example of several wireless communication systems available, such as radio and television broadcasting, and mobile and cordless phones (all land-based systems being known as “terrestrial” systems), satellite communication provides many advantages in area coverage with even the remotest of locals enjoying coverage. Additionally, satellites can be used to supply radio and television signals to terrestrial antennas and transmitters located anywhere, such as the smaller scale antennas described above, as located, for example, in automobiles, trucks, on backpacks and boats, and/or to exchange signals between television stations in any locality. For instance, as shown in FIG. 5, using satellite linked capability the present invention may conveniently transmit location/coordinated encrypted text, sound or imagery to ships at sea, submarines, local ISPs via Broadband Satellite Systems, mountain climbers and space stations alike for rapid and cost effective transmission and retrieval of such information and subject matter.

It is also contemplated that the present invention be employed with any conventional satellite technology, such as that described in the Background of the Invention to achieve any advantage desired, including onboard switching, spot-beam technology, inter-satellite links and constellations of systems in a variety of orbits, such as LEO, MEO, GEO, or Hybrid Orbits (e.g., see Background of The Invention) Furthermore, encrypted information transmitted, received, retrieved, and reconstituted in accordance with the present invention may be the subject matter of any information transmitted in any of the several conventional transmission methods available. More particularly, the present invention may be employed in a protocol which communicates data relating to network variables in a LON control network as secure communications between a protocol identification field and a message identification field. The invention may also be used in a multicast data messaging mode in a communications network to work in conjunction with any known protocol, such as, for example, TCP/IP, HTTP, SMPT, ATM, RTP, RTSP, SAP, and SIP, or any other product enabling packet-switched data transmission through any peripheral device. Other useful examples include navigational devices for vehicles, boats and ships, and any type or permutation of messaging accomplished by the SMS system. The invention may also be conveniently and advantageously utilized to locate and retrieve any type of executable stored or made available in a database or library, or on the Internet, to carry out virtually any type of operation as desired, including automated database searching relating to any type of topic or subject matter to retrieve a myriad of information, such as ships' charts, manuals, geographical and geological information, navigational information.

It will also be appreciated that virtually any type of vending operation, or method of conducting a vending business, for sale and purchase of services, goods and information in general may be conveniently and advantageous varied out by the present invention, perhaps providing distinct advantageous over competitors employing conventional methods.

While this invention has been described in connection with what is presently considered to be the most practical and preferred embodiments, it is to be understood that the invention is not to be limited to the disclosed embodiments in any way which are merely set forth for illustrative purposes; to the contrary, the present inventive method and system, and method for conducting business in general, is intended to cover an array of various modifications and equivalent arrangements all of which are contemplated for inclusion within the spirit and scope of the disclosure and appended claims.

1. A method for transmitting information in the form of text, sound and/or images from a sender to a receiver comprising a transmission means for transmitting location related information, and which comprises a first location database wherein location coordinate pairs are assigned to location specifications in a descriptor means in an information reservoir or retrieval means, a receiver means comprising a second location database for receiving location related information, and wherein said second database further comprises location paired information to which the transmitted information relates, and with at least the assistance of the transmitted information pair selecting a location specification in an information reservoir to retrieve transmitted text, sound and/or images.

2. The method of claim 1, further comprising transmitting descriptors, and comparing the descriptors in the respective location database with similar descriptors.

3. The method of claim 2 wherein the transmitted descriptors comprise location related information enabling the recipient to retrieve transmitted text, sound and/or data information.

4. The method of claim 1 wherein information is transmitted and received through satellite means.

5. The method of claim 4 wherein said information reservoir is the Internet.

6. The method of claim 4 wherein said location related information is transmitted in a modulated format and processed in a demodulated format.

7. The method of claim 6 wherein said location related information is digitally coded.

8. A receiver for digitally coded location-related transmissions of information selected from text, sound and images comprising means for transmitting location-related information between a sender which comprises a first location database in which location coordinate pairs and descriptors are assigned to location specifications and the receiver; a second location database comprising location specifications which store location coordinate pairs and descriptors; means for transmitting, along with the information to be transmitted, at least a coordinate pair of a location to which the information relates, enabling the selection of a location specification from a location database to produce text, sound and/or images.
